(19) United States
(12) Patent Application Publication
(10) Pub. No.: US 2008/0263000 A1
(43) Pub. Date: Oct. 23, 2008

(54) UTILIZING AGGREGATED DATA

(76) Inventors: John Randall West, Sunnyvale, CA (US); Gregory David Neil Hudson, Riverside, IL (US)

Correspondence Address: STRATEGIC PATENTS P.C.., C/O PORTFOLIOIP, P.O. BOX 52050, MINNEAPOLIS, MN, 55402, US

(21) Appl. No.: 12/020,786

(22) Filed: Jan. 28, 2008

Related U.S. Application Data
(60) Provisional application No. 60/886,801, filed on Jan. 26, 2007.

(51) Int. Cl. G06F 17/30

(52) U.S. Cl. 707/2; 707/E17.014; 707/E17.056

(57) ABSTRACT

The present invention describes a method for receiving data within an aggregation facility, precalculating, and fixing a dimension of the data table. The data may be aggregated, wherein at least one data dimension remains flexible. An analytic query may be received that is associated with at least one data dimension. An analytic query may be processed by accessing the aggregated data.

### CROSS-REFERENCE TO RELATED APPLICATIONS

This application claims the benefit of the following provisional application, which is hereby incorporated by reference in its entirety: App. No. 60/886,801 filed on Jan. 26, 2007 and entitled “Utilizing Aggregated Data.”

### BACKGROUND

1. Field

This invention relates to methods and systems for aggregating data and, more specifically, to methods and systems associated with aggregation that allow a flexible dimension in aggregated data.

2. Description of Related Art

Many businesses and other entities, such as research institutions, desire to make analytical projections based on large sets of data, including data sets that change over time in various dimensions. In many cases such projections require aggregating large amounts of data from a data set in various combinations, but with large data sets the range of possible aggregation combinations becomes very large. The calculations to cover a range of possible combinations become more complex and time consuming as the number of dimensions and/or entries within a data set, such as a fact table, increases.

In environments where a data projection is desired, speed in determining an aggregation associated with the projection may also be desired, such as when an analytical projection relates to a time-sensitive decision. The aggregation may be provided with respect to any and all of the dimensions of a data set, such as a fact table. In some cases the dimensions may be categorical and hierarchical, making calculations used to generate the combinations increasingly complex.

The issue of calculation speed may be resolved to some extent by pre-aggregating data associated with a fact table to provide a data table, a data cube, or a data hypercube of projections. This solution, while providing the recipient, such as a customer of a business, with usable data projections, typically fixes the aggregation at certain levels in the hierarchies of the dimensions. This is can be an obstacle later, because a customer may wish to query projections in different ways, such as at different levels in the hierarchies.

Therefore, there is a need for a method that provides both rapid data projection (such as using pre-aggregation) and flexibility at query time with respect to at least one of the hierarchy levels.

These and other systems, methods, objects, features, and advantages of the present invention will be apparent to those skilled in the art from the following detailed description of the preferred embodiment and the drawings.

### SUMMARY

The methods and systems provided herein provide for receiving data within an aggregation facility, precalculating, and fixing a dimension of the data table. In embodiments, data may be aggregated, wherein at least one data dimension remains flexible. An analytic query may be received that is associated with at least one data dimension. An analytic query may be processed by accessing the aggregated data.

In embodiments, the dimension may be a store, a hierarchy, a category, a data segment, a time, a venue, a geography, a demographic, a behavior, a life stage, a consumer segment, a large number of facts or some other attribute.

In embodiments, the flexible dimension may be specified by the user at the time of the query and may be related to a level of hierarchy within the fact table. In addition, the flexible dimension may be selected prior to the user query. Moreover, the use of a flexible dimension may provide user flexibility at the time of the query and may reduce the number of fact tables associated with the aggregation.

In embodiments, the fact table may utilize a bitmap index associated with a bitmap generation facility.

In embodiments, the bitmap index may be generated in relation to the user input and may include a domain. In addition, the bitmap index may include a reference and may aid in the selection of the flexible dimension. Moreover, the bitmap index may be related to report generation, data mining, processing related to data relationships, and data querying. Further, the bitmap index may be generated prior to the user input.

In embodiments, the bitmap generation facility may have a default value. In embodiments, combining may be a cross join between the first source table and the second source table and may be associated with a Cartesian product.

In embodiments, the source fact table contents may change in time related to multiple dimensions. In addition, the source fact table may be a database table and may be associated with a tuple that encode the facts.

In embodiments, aggregation may be performed as pre-aggregation.

In embodiments, the pre-aggregation may be performed prior to the user query.

In embodiments, the projection fact table may be a database table and the pre-aggregation may be associated with the sales data or projection weights.

In embodiments, the tuple may be a finite function that maps a field name to a value.

These and other systems, methods, objects, features, and advantages of the present invention will be apparent to those skilled in the art from the following detailed description of the preferred embodiment and the drawings. Capitalized terms used herein (such as relating to titles of data objects, tables, or the like) should be understood to encompass other similar content or features performing similar functions, except where the context specifically limits such terms to the use herein.

### BRIEF DESCRIPTION OF THE FIGURES

The invention and the following detailed description of certain embodiments thereof may be understood by reference to the following figures:

FIG. 1 depicts a method and system for providing an analytical result from an aggregation.

FIG. 2 depicts a logical diagram of a projected facts table.

FIG. 3 depicts aggregating data and utilizing a flexible dimension.

FIG. 4 depicts utilizing aggregated data.

### DETAILED DESCRIPTION

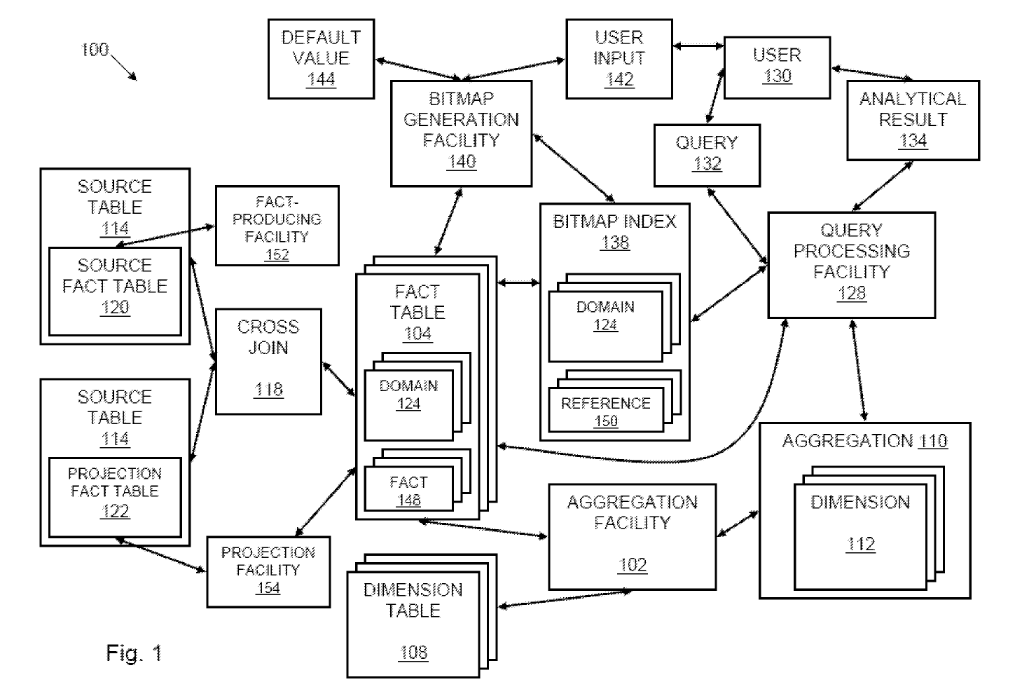

Referring to FIG. 1, an aspect of the present invention 100 involves an aggregation facility 102 producing an aggregation 110 of one or more fact tables 104 and/or dimension tables 108, wherein at least one dimension 112 of the aggregation 110 is flexible. This flexible dimension 112 may be designated and/or defined at or before the time when a query and/or lookup specified, wherein the query and/or lookup may be directed at the aggregation 110 and associated with the dimension 112. The dimension 112 may be associated with hierarchical, categorical information. The definition or designation of the dimension 112 may encompass the specification of a particular level in the information's hierarchy. For example and without limitation, an aggregation 110 may include a time dimension 112. Levels in this dimension's information hierarchy may include second, minute, hour, day, week, month, quarter, year, and so forth. In other words, the aggregation 110 may include a time dimension 112 that is aggregated at the level of seconds, minutes, hours, or any one of the hierarchical levels of the time dimension 112.

In embodiments, a fact table 104 may encompass a Cartesian product or cross join 118 of two source tables 114. It will be appreciated that the fact table 104 may be relatively large as a result of the cross join 118. In some embodiments, one of the source tables 114 may itself consist of a source fact table 120 (e.g., a database table comprising tuples that encode transactions or facts of an enterprise) and the other source table 114 may consist of a projection fact table 122 (e.g., a database table comprising tuples that encode projected transactions or facts of the enterprise). In any case, the aggregation 110 may comprise a value, a tuple, a database table, a data cube, or a data hypercube. The aggregation 110 may consist of dimensions 112 that are associated with domains 124 of the fact table 104, wherein the domains 124 may be associated with the fact table's 104 columns.

In applications, a user 130 of a query processing facility 102 may be engaged in a data warehouse activity. This activity may comprise and/or be associated with a query 132 for producing an analytical result 134 from an aggregation 110. The size and/or organization of the aggregation 110 may result in a relatively long query processing time at the query processing facility 128, which the user 130 may experience during the data warehouse activity. The dimensions 112 of the aggregation 110 may be fixed at particular levels in the dimensions' 112 information hierarchies. The data warehouse activity may comprise data lookups in the aggregation 110. The query processing facility 128 may process such lookups in a relatively speedy manner as compared with the time it takes the application facility 102 to generate the aggregation 110.

In practice the user 130 may want flexibility, at query time, with respect to one or more of the dimensions 112 in the aggregation 110. In other words, the user 130 may want to explore the aggregation 110 with respect to user-selected levels of those dimensions' 112 information hierarchies. In some circumstances, such as when the query processing facility 128 may be providing a distribution measure, the aggregation 110 may not lend itself to such flexibility. For example and without limitation, an aggregation 110 may be provided with respect to three dimensions 112: sales, item, and venue group. The levels of the venue group dimension 112 may include store, city, region, metropolitan statistical area, and so forth. Suppose the aggregation 110 were provided by the aggregation facility 102 with the venue group dimension 112 aggregated and fixed at the regional level. If the user were to issue a query 132 requesting the percentage of total sales that are attributed to a particular store, it might be impossible for the query processing facility 128 to calculate the answer solely by referencing the aggregation 110: the sales of individual stores, in this example, are aggregated at the regional level in the venue group dimension 112 and not the store level. To accommodate the user 130, the query processing facility 128 may instruct the aggregation facility 102 to generate another aggregation 110, this one with the venue group dimension 112 fixed at the store level. Or, the query processing facility 128 may use a pre-computed alternate aggregation in which the venue group dimension 112 is fixed at the store level. In either case, an alternate aggregation may be required. An object of the present invention may to provide a way of accommodating the user 130 without using an alternate aggregation.

An aspect of the present invention may be understood with reference to the following example, which is provided for the purpose of illustration and not limitation. This example deals with queries that provide flexibility with respect to one dimension, but it will be appreciated that the present invention supports flexibility with respect to more than one dimension. Given a sales fact table (sales f act) including venue, item, and time dimensions and a projection fact table (projection) including venue, time, and venue group dimensions, and given that each sales fact in the fact table contains actual sales data and each fact in the projection table contains a projection weight to be applied to actual sales data so as to produce projected sales information, then the following query may produce projected sales aggregations for all combinations of venue and product category:

SELECT
venue_dim_key,
item_dim.attr1_key,
sum(projection.weight * salesfact.sales)
FROM salesfact, projection, item_dim, time_dim
WHERE (

// 13 weeks of data
(time_dim.qtr_key = 11248)
// break out the 13 weeks
AND (salesfact.time_dim_key = time_dim.time_dim_key)
// join projection and salesfact on venue_dim_key
AND (projection.venue_dim_key = salesfact.venue_dim_key)
// join projection and salesfact on time_dim_key
AND (projection.time_dim_key = salesfact.time_dim_key)
// break out a group of venues
AND (projection.venue_group_dim_key = 100019999)
// some product categories
AND (item_dim.attr1_key in (9886, 9881, 9267))
// break out the items in the product categories
AND (item_dim.item_dim_key = salesfact.item_dim_key))

GROUP BY venue_dim_key, item_dim.attr1_key

It will be appreciated that this projection query could take a long time to process if the venue group involved is large (i.e., contains a lot of stores) and/or a long period of time is desired. An advantage of the present invention is provided through the pre-aggregation of sales data and projection weights into a projected facts table (not to be confused with the projection fact table). The projected facts table (projectedfact) contains projected facts stored keyed by time, item, and venue group. The projected facts table may contain projected sales (projectedfact.projectedsales) that result from aggregating projection.weight times salesfacts.sales grouped by time, item, and venue group. Having calculated the projected facts table, it is possible to produce projected sales aggregations according to the following query:

SELECT
venue_dim_key,
item_dim.attr1_key,
sum(projectedfact.projectedsales)
FROM projectedfact, item_dim, time_dim
WHERE (

// 13 weeks of data
(time_dim.qtr_key = 11248)
// break out the 13 weeks
AND (projectedfact.time_dim_key = time_dim.time_dim_key)
// break out a group of venues
AND (projectedfact.venue_group_dim_key = 100019999)
// some product categories
AND (item_dim.attr1_key in (9886, 9881, 9267))
// break out the items in the product categories
AND (item_dim.item_dim_key = projectedfact.item_dim_key))

GROUP BY venue_dim_key, item_dim.attr1_key

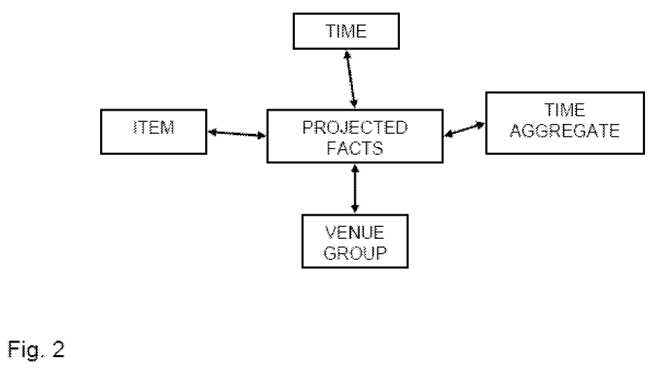

As compared with the first example query, it will be appreciated that flexibility remains in the item dim dimension while the number of fact tables is reduced to one. In addition, it will be appreciated that, due to the projected facts being aggregated on venue groups, facts that were originally represented by venue are compressed down into aggregated facts that correspond to venue groups. In embodiments, the number of venues in a group can exceed 1,000, so this compression can provide a significant (in this example, perhaps a 1000:1 or greater) reduction in the time required to produce projected sales aggregations. Similarly, the projected facts table may store projected sales that are aggregated by time period, which could still further reduce the time required to produce projected sales aggregations. In all, these improvements may accommodate the user 130 by reducing the time required to generate projected sales aggregations while providing flexibility with respect to at least one dimension. This reduction in the time required may be so significant that it allows the user 130 to interactively select a point along the flexible dimension and see the resulting projected sales aggregations in or near real time. (For reference, the projectedfact table is depicted in FIG. 2.)

Another aspect of the invention may relate to a bitmap index 138 into the fact table 104, which may be generated by a bitmap generation facility 140. The domains 124 of the index 138 may be selected from the fact table 104 so as to allow flexibility along a specific dimension 112 of the aggregation 110. The bitmap index 138 may be generated in response to a user input 142, such as and without limitation a specification of which dimension or dimensions should be flexible. Alternatively or additionally, the bitmap index 138 may be generated in advance, such as and without limitation according to a default value 144. The bitmap index 138 may be embodied as a binary and/or or may be provided by a database management system, relational or otherwise.

The following example is provided for the purposes of illustration and not limitation. One or more fact tables 104 encompassing an item domain 124, a time domain 124, a venue domain 124, and a venue group domain 124 may be provided. Facts 148 within these fact tables 104, which may be embodied as rows of the tables, may relate to actual and/or projected sales, wherein a sale may be encoded as a time of sale, an item sold, and the venue and/or venue group associated with the sale. The aggregation 110 produced from the one or more fact tables 104 may comprise a sales dimension 112, an item dimension 112, and a venue group dimension 112 aggregated at the regional level. A user 130 may specify (such as via the user input 142) that he is interested in the percentage of total sales that are attributed to a particular venue. Perhaps in response to this specification and/or perhaps in accordance with the default value, the bitmap generation facility 140 may create a bitmap index 138 containing a reference 150 for each value in the venue and item domains 124 of the one or more fact tables 104; any and all of the references 150 may comprise an entry, vector, pointer, or the like. In other words, each of the references 150 in the bitmap index 138 may encode the location of the facts 148 that correspond to each venue and each item. Given these locations, the total sales for a particular venue may be calculated: the location of all the facts 148 that are associated with the venue are encoded in the index; the query processing facility 128 may utilize the bitmap index to rapidly locate the facts 148 that correspond to the venue. Since each fact 148 may correspond to an item sold, the query processing facility 128 may count the facts 148 that it located to determine the number of items sold. Meanwhile, the total sales for all stores may be calculated by summing all of the sales values of all of the items in all of the venue groups of the aggregation 110. The ratio of total sales for the venue to total sales for all venue groups, which may be the analytical result 134, may be the percentage of total sales in which the user 130 expressed interest. It will be appreciated that, in embodiments, it may not be possible to produce the analytical result 134 for the user 130 by simply counting the facts 148 located via the index 138. In such cases, any and all of those facts 148 may be accessed and one or more values of those facts 148 may be summed, aggregated, or otherwise processed to produce the analytic result 134. In any case, it will be appreciated by those skilled in the art that the bitmap index 138 may provide dramatic improvements in system performance of the query processing facility 128 when it is producing an analytical result 134, such as and without limitation a percentage of total sales that are attributed to a particular venue and so forth.

The facts 148 may be embodied as tuples or rows in a fact table and may comprise numbers, strings, dates, binary values, keys, and the like. In embodiments but without limitation, the facts 148 may relate to sales. The facts 148 may originate from the source fact table 102 and/or the projection fact table 122. The source fact table 120 may in whole or in part be produced by a fact-producing facility 152. The projection fact table 122 may in whole or in part be produced by a projection facility 154. In embodiments, the fact-producing facility 152 may without limitation encompass a point-of-sale facility, such as a cash register, a magnetic stripe reader, a laser barcode scanner, an RFID reader, and so forth. In embodiments the projection facility may without limitation consist of computing facility capable of generating part or all of the projection fact table 122, which may correspond to projected sales. In embodiments, the bitmap generation facility 140 may index the facts 148, producing the bitmap index 138. The query processing facility 128 may utilize the bitmap index when processing certain queries 132 so that as to provide improved performance, as perceived by the user 130, without utilizing an auxiliary aggregation 110. In embodiments, there may or may not be at least one reference 140 in the bitmap index 138 for any and all of the facts 148. In embodiments, there may be indexes 138 and/or references 150 for aggregated, pre-aggregated, and/or non-aggregated facts 148. In embodiments, the index 138 may be embodied as a bitmap index.

In embodiments, the query processing facility 128 may use the fact table 104, the aggregation 110, and/or and the index 138 to provide a user-defined data projection, which may be the analytical result 134. In an embodiment, the fact table 104 may provide input to the projection facility 154, which may or may not utilize that input to produce the projection fact table 122. In an embodiment, the query processing facility 128 may process the facts 148 by pre-aggregating them in a predefined manner, for example and without limitation as may be defined by the user input 142 or the default value 144. In embodiments, the predefined manner may include not pre-aggregating at least one domain 124 of the fact table 104 (wherein the one domain 124 may or may not be used in a later query 132); generating an index 138 that is directed at providing flexibility at query time with respect to at least one dimension 112 of the pre-aggregation 110 (whether or not one or more domains 124 of the fact table 104 have been pre-aggregated); and so forth. In embodiments, a user 130, a default value 144, a projection provider (which may be an entity that employs the present invention), a value associated with a market, or the like may define at least one domain 124 and/or at least one dimension 112. This domain 124 and/or this dimension 112 may be the same for all of a plurality of users 130; may be different for some or all of the plurality of users 130; may be associated with a particular projection fact table 122 and/or fact table 104; and so on. In an embodiment, the query processing facility 128 may provide an output to an end user 130. The output may comprise or be associated with the user-defined data projection (i.e., the analytical result 134). The analytical result 134 may be a value, table, database, relational database, flat file, document, data cube, data hypercube, or the like. In an embodiment, a user 130 may submit a query 132 in response to the analytical result 134 and/or the analytical result 134 may be a result that is produced by the query processing facility 128 in response a query 132 that is associated with the user 130.

As an example, an enterprise may track sales of various products from a plurality of stores. All of the facts 148 associated with the different products may be collected and indexed in preparation for report generation, data mining, processing related to data relationships, data querying, or the like. All of the facts 148 may be aggregated by the aggregation facility 102. Alternatively or additionally, the facts 148 that relate to, pertain to, represent, or are associated with a particular domain 124 may not be aggregated. The bitmap generation facility 140 may generate a bitmap index 138 to enable or expedite certain queries. In any case, the end user may be able to submit a query 132, perhaps in association with a data mining activity, that is received by the query processing facility 128 and that results in the query processing facility 128 generating an analytical result 134, wherein the production of the analytical result may have depended upon one or more of the dimensions 112 of the aggregation 110 being flexible. This flexibility may be associated with the query processing facility's 128 use of the bitmap index 138.

It should be appreciated that various combinations of fixed and flexible dimensions are supposed by the present invention. All such combinations are within the scope of the present disclosure. For example and without limitation, an embodiment may implement two fixed dimensions (i.e., venue [via venue group] and time dimensions) and two flexible dimensions (i.e., item and causal dimensions).

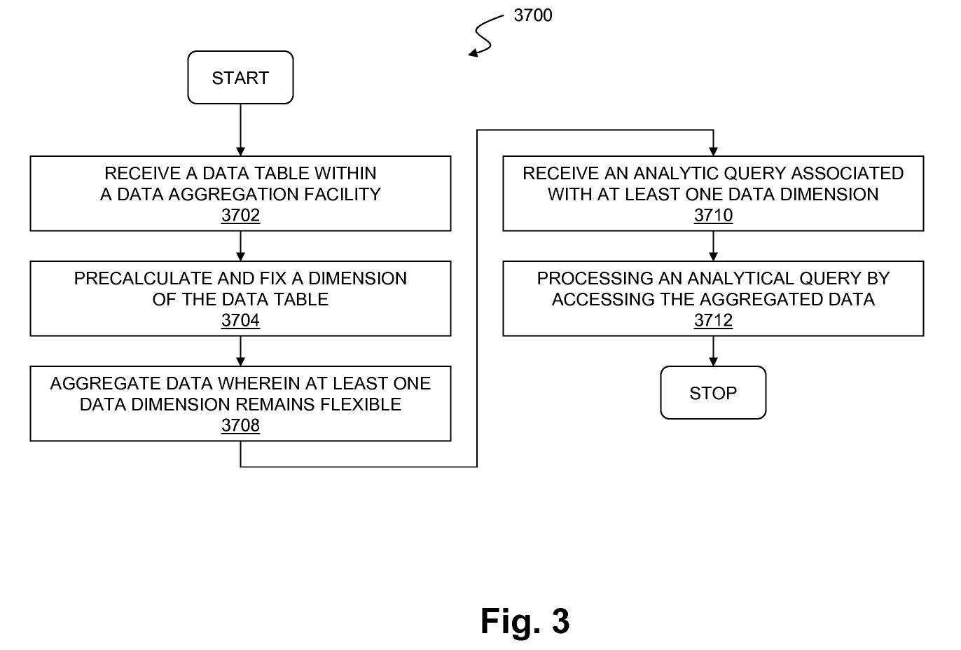

FIG. 3 illustrates a flow chart explaining a method for aggregating data and utilizing a flexible dimension according to an embodiment of the present invention. The process begins at logical block 3702, where a data table may be received within data aggregation facility. A dimension of the data table may be precalculated and fixed 3704. In embodiments, data may be aggregated, wherein at least one data dimension remains flexible 3708. An analytic query may be received that is associated with at least one data dimension 3710. An analytic query may be processed by accessing the aggregated data 3712.

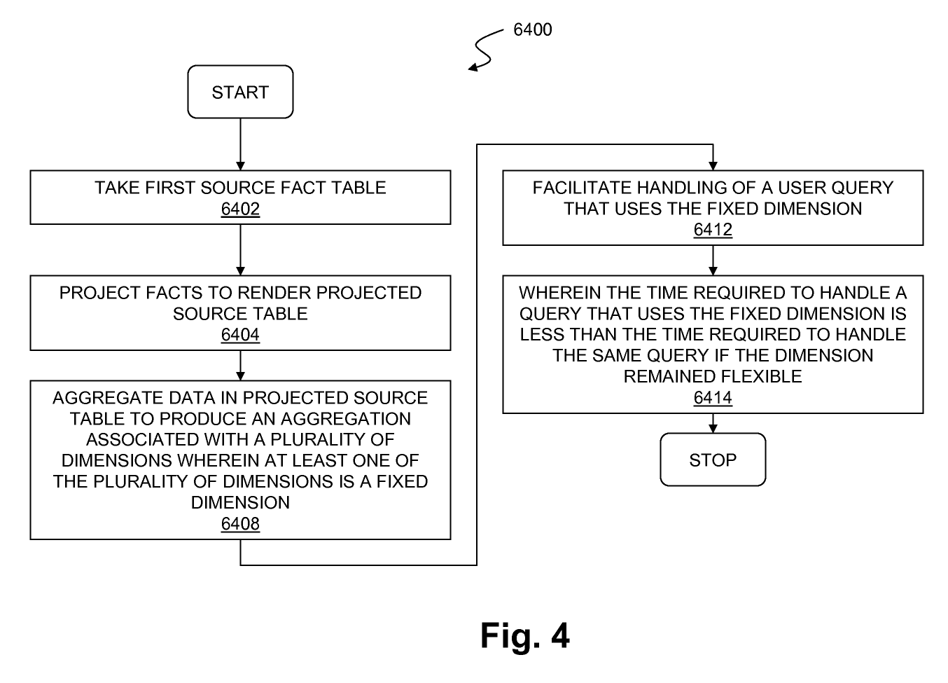

Referring to FIG. 4, a logical process 6400 in accordance with various embodiments of the present invention is shown. The process 6400 is shown to include various logical blocks. However, it should be noted that the process 6400 may have all or fewer of the logical blocks shown in the FIG. 4. Further, those skilled in the art would appreciate that the logical process 6400 can have more logical blocks in addition to the logical blocks depicted in the FIG. 64 without deviating from the scope of the invention.

In embodiments, a first source fact table may be provided at logical block 6402. The data set may be a fact table 104. The fact table 104 may include a large number of facts. Further, the fact table 104 may utilize a bitmap index associated with a bitmap generation facility 140. The bitmap index may be generated in relation to the user input and may include a domain. In addition, the bitmap index may include a reference and may aid in the selection of a flexible dimension. Moreover, the bitmap index may be related to report generation, data mining, processing related to data relationships, and data querying. Further, the bitmap index may be generated prior to the user input.

In embodiments, facts may be provided in the source fact table to render a projected source table 6404. Data in the projected source table may be aggregated to produce an aggregation associated with a plurality of dimensions, wherein at least one of the plurality of dimensions is a fixed dimension 6408. In embodiments, handling of a user query that uses the fixed dimension may be facilitated 6412, the time required to handle a query that uses the fixed dimension is less than the time required to handle the same query if the dimension remained flexible 6414.

In embodiments, one or more dimension of the multiple dimensions may be a flexible dimension. The flexible dimension may be specified by the user at the time of query. Alternatively, the flexible dimension may be selected prior to the user query. Further, the flexible dimension may be related to a level of hierarchy within the fact table 104.

In embodiments, a user may be able to generate a query in association with a query processing facility 128. In embodiments, the query may be related to a use of the flexible dimension. The use of the flexible dimension may provide the user with flexibility at the time of the query. Further, the use of flexible dimension may reduce the number of fact tables associated with the aggregation.

Finally, an analytic result may be presented to the user based on the user query. In embodiments, an elapsed time between the query and the presentation of the analytic results may be relatively small as compared to the time taken to execute the query without utilizing the flexible dimension.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method comprising:
receiving a pre-aggregated data set within a data aggregation facility;
pre-calculating and fixing data for a dimension of the data table;
aggregating data within the data aggregation facility, wherein data associated with at least one of the data dimensions remains flexible; and
processing an analytical query by accessing the aggregated data.

2. The method of claim 1, further comprising, permitting an analytical query that requires varying the fixed dimension of the data table by applying the analytical query to the pre-aggregated data set.

3. The method of claim 1, wherein the dimension is a store.

4. The method of claim 1, wherein the dimension is a hierarchy.

5. The method of claim 1, wherein the dimension is a category.

6. The method of claim 1, wherein the dimension is a data segment.

7. The method of claim 1, wherein the dimension is a time.

8. The method of claim 1, wherein the dimension is a venue.

9. The method of claim 1, wherein the dimension is a geography.

10. The method of claim 1, wherein the dimension is a demographic.

11. The method of claim 1, wherein the dimension is a behavior.

12. The method of claim 1, wherein the dimension is a life stage.

13. The method of claim 1, wherein the dimension is a consumer segment.

14. A method comprising:
receiving a pre-aggregated data set within a data aggregation facility;
pre-calculating and fixing data for a dimension of the data table;
aggregating data within the data aggregation facility, wherein data associated with at least one of the data dimensions remains flexible; and
processing an analytical query by accessing the aggregated data; and permitting an analytical query that requires varying the fixed dimension of the data table by applying the analytical query to the pre-aggregated data set.

15. A method comprising:
taking a first source fact table;
projecting facts in the first source fact table to render a projected source table;
aggregating data in the projected source table to produce an aggregation associated with a plurality of dimensions, wherein at least one of the plurality of dimensions is a fixed dimension; and
facilitating handling of a user query that uses the fixed dimension, wherein the time required to handle a query that uses the fixed dimension is less than the time required to handle the same query if the dimension remained flexible.

16. The method of claim 15, further comprising permitting the user to elect to render the fixed dimension flexible and facilitating handling of a user query that uses the projected source table.

17. The method of claim 15, wherein the use of a flexible dimension provides user flexibility at the time of the query.

18. The method of claim 15, wherein the use of a fixed dimension reduces the number of dimensions required to be processed by a query.

19. The method of claim 15, wherein the fixed dimension is specified by the user at the time of the query.

20. The method of claim 15, wherein the fixed dimension is related to a level of hierarchy within the fact table.

21-51. (canceled)
